(19) United States
(12) Patent Application Publication
(10) Pub. No.: US 2012/0166810 A1
(43) Pub. Date: Jun. 28, 2012

(54) Biometrically Securing and Transmitting Data

(76) Inventors: Leon Tao, Millbrae, CA (US); David Tao, Millbrae, CA (US)

(21) Appl. No.: 13/282,942

(22) Filed: Oct. 27, 2011

Related U.S. Application Data
(60) Provisional application No. 61/460,154, filed on Dec. 27, 2010.

(51) Int. Cl. G06F 21/00

(52) U.S. Cl. 713/186

(57) ABSTRACT

The disclosed technology combines biometric authentication and data transmission technologies to provide for secure storing of private information and wireless transmission of the private information in order to perform predefined tasks. A user may securely store his private information in an electronic database. To access the private information stored securely, the user provides his biometric data. Upon successful biometric authentication of the user, authorization is granted to the user to access the private information stored in the electronic database. Upon successful biometric authentication, the private information can be transmitted via short range wireless communication. Optionally, upon successful biometric authentication, the private information can be transmitted via wireless communication over a computer network.

### CROSS-REFERENCE TO RELATED APPLICATIONS

This application claims the benefit of U.S. provisional application Ser. No. 61/460,154, filed Dec. 27, 2010, entitled “Method and Technology Used for a Portable Device with Biometric Secured Database and Transceivers,” which is hereby incorporated herein in its entirety by reference.

### FIELD OF TECHNOLOGY

The present disclosure relates to controlling access to data and authorizing transmission of the data; more particularly, the present disclosure is directed to biometric authentication and transmissions of private information.

### BACKGROUND

Every day, people carry around with them many necessary personal items. These personal items may include wallets, purses, cash, credit cards, debit cards, bus/train passes, car keys, house keys, access badges, insurance cards, ID cards, mobile phones, etc. Individually as well as collectively, these items can take up a lot of space and may be heavy and/or burdensome to carry around. Moreover, it can be a hassle to find and get an item to use it. For example, a person must take out his wallet and find cash or credit/debit cards to make purchases. Another example is when a person has to locate the correct key amongst a plethora of keys to lock/unlock his house door. Similarly, a person will have to find the appropriate key to unlock his car and turn on the ignition. A further example is a person having to remember a passcode/combination and then input that passcode/combination to unlock a lock/safe and/or enter into a computer system.

To address some of the aforementioned issues, “contactless” or “touchless” cards have been developed. For example, contactless or touchless credit cards include special credit cards that allow a user to wave, place, or tap his credit card in front of a special payment terminal to trigger a payment transaction, instead of the conventional swiping/sliding of the credit card. However, a problem with this approach is that the user will still have to carry multiple cards (e.g., debit and credit cards, credit/debit cards from different institutions). More importantly, this approach has the same security problems of conventional cards. For example, if a special contactless/touchless card is lost or stolen, another (unauthorized) user may still attempt to use it.

There has also been an attempt for a biometric payment system (e.g., by the former Pay By Touch® company) in which a user uses his fingerprint and a passcode/ID number at a point of sale (POS) terminal to authenticate his identity and make a payment, thereby replacing the need for credit/debit cards. However, this approach has the problem of requiring a user to provide and surrender his private biometric (fingerprint) information to the system and company (Pay By Touch®). For example, with this system, a user must give up his own private fingerprint data to the system/company during a registration process before using this payment service. There may also be legal issues surrounding the acquisition and possession by a company of an individual's private fingerprint data for commercial use. Moreover, there are many technical problems related to this system/service. For example, in this system, a user's fingerprint and other information is stored on a remote server along with many other users. As such, the fingerprint authentication (e.g., fingerprint comparison and matching) and payment process can take a long time and encounter accuracy/reliability problems, especially when the network is jammed with heavy traffic from multiple users using the system (e.g., at the same time). Not only might a user wait for a long time at a POS terminal, but he may even encounter embarrassment when this system returns a false rejection (e.g., an incorrect unsuccessful authentication) due to the problems relating to fingerprint sensing and/or relating to lag, accuracy, and/or reliability.

### SUMMARY

Additional features and advantages of the concepts disclosed herein are set forth in the description which follows, and in part will be obvious from the description, or may be learned by practice of the described technologies. The features and advantages of the concepts may be realized and obtained by means of the instruments and combinations particularly pointed out in the appended claims. These and other features of the described technologies will become more fully apparent from the following description and appended claims, or may be learned by the practice of the disclosed concepts as set forth herein.

The present disclosure describes combining biometric authentication and data transmission technologies to provide for secure storing of private information and wireless transmission of the private information in order to perform predefined tasks. A user may securely store his private information in an electronic database. To access the private information, the user provides his biometric data, which is unique to him and unlikely to change. Upon successful biometric authentication of the user, authorization is granted to the user (i.e., a device controlled by the user) to access the private information stored in the electronic database. Upon successful biometric authentication, the private information can be transmitted via short range wireless communication. Optionally, upon successful biometric authentication, the private information can be transmitted via wireless communication over a computer network (including a cellular phone network).

In some embodiments, the disclosed technology comprises an electronic database, a biometric acquisition module, a processor, and a short range wireless communication transceiver. The processor can facilitate communication among the components. The electronic database can store a user's private information, which can include his unique biometric data. The biometric acquisition module can acquire biometric data from a user attempting to access the private information in the electronic database. The biometric acquisition module and/or processor can optionally implement a biometric authentication algorithm to authenticate the user based on his biometric data. The short range wireless communication transceiver can transmit the private information based on successful authentication. Optionally, there can be a wireless communication transceiver for transferring, upon successful authentication, the private information over a computer network.

In some embodiments, the disclosed technology comprises a data reader that can receive the transmitted private information and utilize it. The data reader can process the private information and provide a response. For example, the data reader can reside at a payment terminal or at a barrier. In some embodiments, the disclosed technology comprises a server connected to a computer network that can receive the transmitted private information and utilize it. The server can process the private information and provide a response, or command a data reader to do so. In some embodiments, a data reader can reside on the server.

In some embodiments, the biometric acquisition module is a fingerprint recognizer, the biometric data is fingerprint data, and the optional biometric authentication algorithm is a fingerprint authentication algorithm. In some embodiments, the short range wireless communication transceiver utilizes near field communication (NFC) technology. For example, a user can access his private information by having his fingerprint authenticated by the fingerprint recognizer. The NFC transceiver can transmit the private information which can then be utilized (e.g., by a data reader and/or server). In some embodiments, a fingerprint recognizer and a NFC transceiver can be integrated with or externally attached to a smartphone, such that the smartphone can provide a user interface for configuring and using these components. In some embodiments, the fingerprint recognizer and NFC transceiver can operate in a stand-alone device.

The foregoing and other objects, features and advantages of the present disclosure will become more readily apparent from the following detailed description of exemplary embodiments as disclosed herein.

### BRIEF DESCRIPTION OF THE DRAWINGS

In order to best describe the manner in which the above-described embodiments are implemented, as well as define other advantages and features of the disclosure, a more particular description is provided below and is illustrated in the appended drawings. Understanding that these drawings depict only exemplary embodiments of the invention and are not therefore to be considered to be limiting in scope, the examples will be described and explained with additional specificity and detail through the use of the accompanying drawings in which:

FIG. 1 illustrates an exemplary device embodiment;

FIG. 2 illustrates an exemplary system embodiment;

FIG. 3A illustrates an exemplary device embodiment integrated within a portable electronic device;

FIG. 3B illustrates an exemplary device embodiment externally attached to a portable electronic device;

FIG. 3C illustrates an exemplary device embodiment operating as a stand-alone device;

FIG. 4A illustrates an exemplary system embodiment;

FIG. 4B illustrates an exemplary system embodiment;

FIG. 4C illustrates an exemplary system embodiment;

FIG. 4D illustrates an exemplary system embodiment;

FIG. 5 illustrates an exemplary method embodiment; and

FIG. 6 illustrates an exemplary system embodiment.

### DETAILED DESCRIPTION

Various embodiments of the disclosure are discussed in detail below. While specific implementations are discussed, it should be understood that this is done for illustration purposes only. A person skilled in the relevant art will recognize that other embodiments, implementations, variations, steps, and/or orders of steps may be used without parting from the spirit and scope of the disclosure.

The present disclosure combines biometric authentication and data transmission technologies to provide for secure storage of private information and wireless transmission of the private information in order to perform predefined tasks.

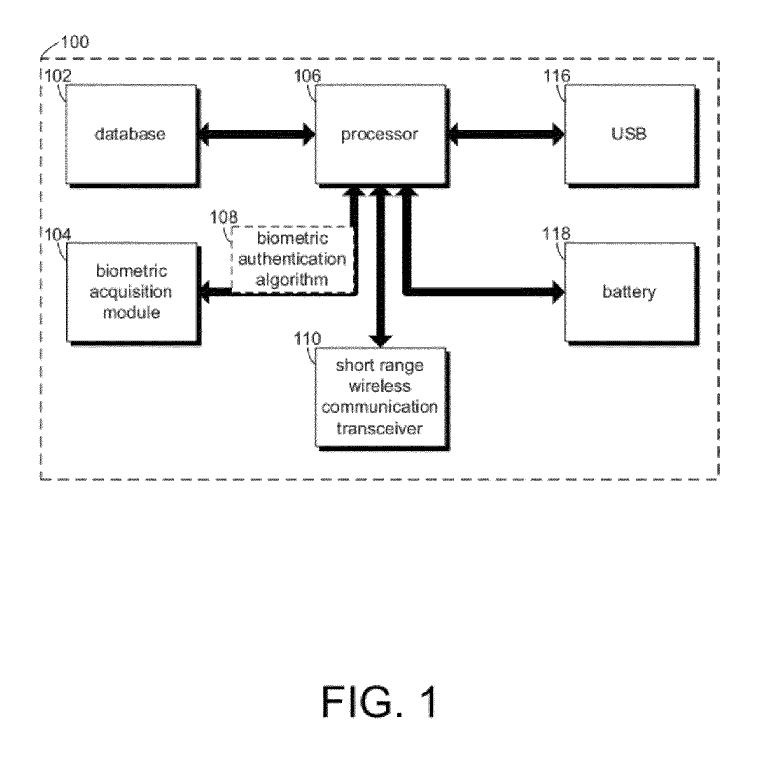

FIG. 1 illustrates an exemplary device embodiment. An exemplary embodiment of a device 100 comprises an electronic database 102, a biometric acquisition module 104, a processor 106, and a short range wireless communication transceiver 110. These components can be interconnected or the processor 106 can facilitate intercommunication amongst the other components. The electronic database 102 can be configured to store private information. Private information is any information that is not intended for general public access. In some embodiments, private information can include payment information (e.g., information relating to credit/debit cards, bank accounts, checking accounts, online payment accounts, transportation accounts), personal information (e.g., names, social security numbers, birthdates, biometric data, medical information, insurance information), contact information (e.g., phone numbers, addresses, emails), confidential information, data, security codes, access badge codes, passwords, keys, etc.

The electronic database 102 can securely store private information, like an electronic safe, by working in conjunction with the biometric acquisition module 104, such that an unauthenticated/unauthorized user is prevented from accessing the private information. The biometric acquisition module 104 of the device 100 can be configured to acquire biometric data (which is unique to a user and also a type of private information) from a user. The module 104 can be used to recognize and/or identify a particular user. It can be used to differentiate between multiple different users.

The processor 106 can facilitate communication amongst the database 102, the biometric acquisition module 104, and/or the wireless communication transceiver 110. The processor 106 can be configured to authenticate a user when biometric data acquired from the user (which is unique to the user) satisfies an authentication criterion. An authentication criterion (or criteria) can be defined and/or approved based on the (unique) biometric data of the user. The criterion and/or the biometric data can be stored locally (e.g., in the database 102 or some other local memory of the device 100). Storing criteria and/or the biometric data locally allows authentication to be performed locally and quickly (e.g., in real-time). This reduces the need to remotely search (e.g., on a non-local server) a potentially large set of approved criteria to find one criterion matching that from the acquired biometric data from the user. Rather, the local database 102 (e.g., of the device 100), likely having a much smaller set of approved criteria, can be searched quickly (e.g., in real-time) to find a matching criterion included in the acquired biometric data.

The authentication of the user is successful if the user's acquired biometric data satisfies at least one authentication criterion. In some embodiments, the device 100 can implement a biometric authentication algorithm 108, which allows for accurate and reliable performance of biometric authentication in real-time. The algorithm 108 can be applied on the acquired biometric data to determine whether the data satisfies an authentication criterion (or criteria). The algorithm 108 can be used in the initiation process to define and/or approve an authentication criterion.

For example, during initiation (e.g., first time use or an enrollment process) of the device 100, the biometric acquisition module 104 can acquire biometric data from a user. The module 104 (and/or the processor 106) can apply a biometric authentication algorithm 108 on the acquired biometric data to analyze the data. The algorithm 108 can, for example, recognize the unique biometric data and denote it as being associated with an authenticated and authorized user. An authentication criterion can be defined and/or approved based on the biometric data. The criterion and/or the unique biometric data can be stored locally on the device 100. Thereby, an authenticated/authorized user is enrolled and an authentication criterion approved. Subsequently, when a user attempts to access the device, the biometric acquisition module 104 can acquire the user's biometric data and the biometric authentication algorithm 108 can determine whether the acquired data satisfies a previously approved authentication criterion (criteria). For example, if the acquired biometric data matches at least one of those previously approved, then the authentication criterion is satisfied and the user authenticated. If not, then the user is not authenticated and not authorized.

Based on the successful biometric authentication of the user (i.e., if authentication produces a positive result), the processor 106 can authorize access to private information stored in the database 102. More particularly, based on the successful biometric authentication of the user, the processor 106 can be configured to authorize transmission of private information stored in the database 102. As such, the device 100 can comprise a short range wireless communication transceiver 110.

The short range wireless communication transceiver 110 can be configured to transmit private information, for example, as authorized by the processor 106. The short range wireless communication transceiver 110 can utilize short range wireless technologies, such as radio frequency identification (RFID) and/or near field communication (NFC) technologies. The short range wireless communication transceiver 110 can generally operate at low power and at distances up to 4 centimeters, or in some embodiments at distances of approximately 10 millimeters. An advantage of the short range wireless communication transceiver 110 is that it communicates at short range distances, such that if an unauthorized user attempts to access the device (e.g., steal private information or hack the database during the private data transmission period), then that unauthorized user must be within a short range distance from the device 100 making theft less likely.

Other optional embodiments can be employed to further help prevent unauthorized use of the device. For example, private information stored in the database 102 of the device can be encrypted. Upon successful biometric authentication (i.e., if the authentication produces a positive result), the processor 106 can authorize transmission of the encrypted private information. In some embodiments, the processor 106 grants authorization to access private information for only a short amount of time, which can have a default length or a user-defined length. Upon successful biometric authentication, the processor 106 can allow authorized transmission of private information only within the time period. Outside the short period of time, the processor 106 terminates the authorization (e.g., the database storing the private information will be inaccessible and/or the transceiver for transmitting private information will be put in a “non-active” state; the device will be in a “locked” state; any private information in the short range wireless transceiver (e.g., stored temporarily in the short range wireless transceiver) ready to be transmitted over short range communication is erased. The inaccessible database and the non-active transceiver are two layers of security that reduce the likelihood of unauthorized use. A person of ordinary skill in the art will recognize that other protection technologies can be implemented as well (e.g., in hardware and in software).

In some embodiments, a device 100 has a biometric acquisition module 104 in the form of a fingerprint recognizer. During initiation, the fingerprint recognizer acquires biometric data from a user by scanning the user's fingerprint. The module 104 (and/or processor 106) can implement a biometric authentication algorithm 108 in the form of a fingerprint authentication algorithm to recognize the acquired fingerprint data and define an authentication criterion. An authentication criterion (or criteria) can be defined, for example, based on the unique characteristic(s) associated with the fingerprint data of the user. The fingerprint data (or a representation thereof) and/or authentication criterion can be stored in an electronic database 102 of the device 100. The user is thereby enrolled and can securely store private information in the database 102 of the device 100. It is contemplated that multiple fingerprints from the same user can be enrolled into the database 102 of the device 100. It is also contemplated that multiple users can be authenticated, authorized, and enrolled as well.

Subsequent to initiation, a user may wish to access some or all of the private information stored securely in the database 102. The fingerprint recognizer acquires the user's fingerprint data and the fingerprint authentication algorithm determines whether the acquired data satisfies an authentication criterion. In some embodiments, if the acquired fingerprint data matches the data representing at least one of those fingerprints previously approved and stored in the device 100, then it satisfies an authentication criterion and the user is authenticated. If the subsequent user's fingerprint data does not match data representing a previously approved fingerprint, then no authentication criteria is satisfied and the subsequent user will not be authenticated and will not be given authorization.

In some embodiments, the device 100 can also include, inter alia, a data interface 116 (e.g., a USB interface) and a battery 118. The data interface 116 can be used for data communications (e.g., firmware loading, firmware upgrading/updating, inputting and/or storing private information via a computer). The battery 118 powers the device 100, can be a rechargeable battery, and can be charged, for example, by using the data interface 116.

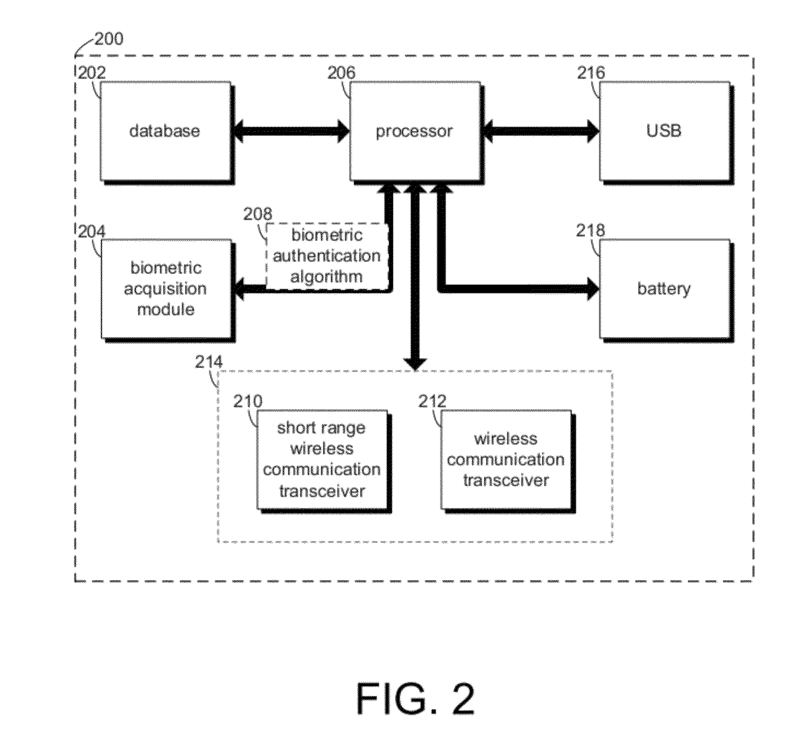

FIG. 2 illustrates an exemplary system embodiment. In some embodiments, a system 200 can comprise a wireless communication transceiver 212 configured to communicate over a computer network, such as the Internet or an intranet. In some situations, short range wireless communication may be inappropriate. Thus the system 200 can optionally include a wireless communication transceiver 212 (e.g., cellular, Bluetooth, 802.11 series) configured to transmit/receive data wirelessly over a computer network, such as the Internet. In this way, the system 200 can preferably use its short range wireless communication transceiver 210 to transmit private information more securely, but also use its wireless communication transceiver 212 to transmit/receive information over a computer network, such as when short range wireless communication may be inappropriate. The wireless communication transceiver 210 can utilize Bluetooth, Wi-Fi, 802.11 series, cellular, 2G, EDGE, 2.5G, 3G, 4G, LTE, or similar wireless communication technologies for communicating over a computer network, such as the Internet. Optionally, the system 200 can comprise a transceiver 214 with capabilities for both short range wireless communication 210 and wireless communication 212 over a computer network.

Moreover, in some embodiments, a short range wireless communication transceiver can operate alongside a wireless communication transceiver configured to communicate over a computer network. For example, a device or system may utilize its short range wireless communication transceiver to transmit (private) payment information for a purchase, while its wireless communication transceiver can receive over a computer network a receipt for the purchase, or, in the case of electronic merchandise, the purchased item itself (e.g., e-book, picture, music, video, media, software, data).

Furthermore, by utilizing its wireless communication transceiver, the device or system can transmit private information over a computer network to another device or system (e.g., similar device or system of a different user). The other device or system can receive the private information via its respective wireless communication transceiver and utilize that private information. For example, a user can transmit his credit card information over the internet to another user. The other user can receive the credit card information from the first user, and then make a payment by transmitting that credit card information via short range wireless communication (e.g., to a payment terminal having short range wireless capabilities). In another example, a user can transmit his passcode/key to another user. The passcode/key can be transmitted over the Internet by the first user's wireless communication transceiver and received by the second user's wireless communication transceiver. Once received, the second user can use his short range wireless communication transceiver to utilize that passcode/key to unlock and/or gain access over a barrier (e.g., the barrier/lock having short range wireless capabilities), such as a locked door, a turned-off car ignition, a locker, a safe, etc.

In some embodiments, the device (or system) can be fit into a very small electronic device package (e.g., approximately less than half the size of a typical credit card). As such, the device can be integrated within a portable electronic device (e.g., cellular phone, smart phone, portable gaming device, etc.), or externally attached to a portable electronic device, or operate as a stand-alone device.

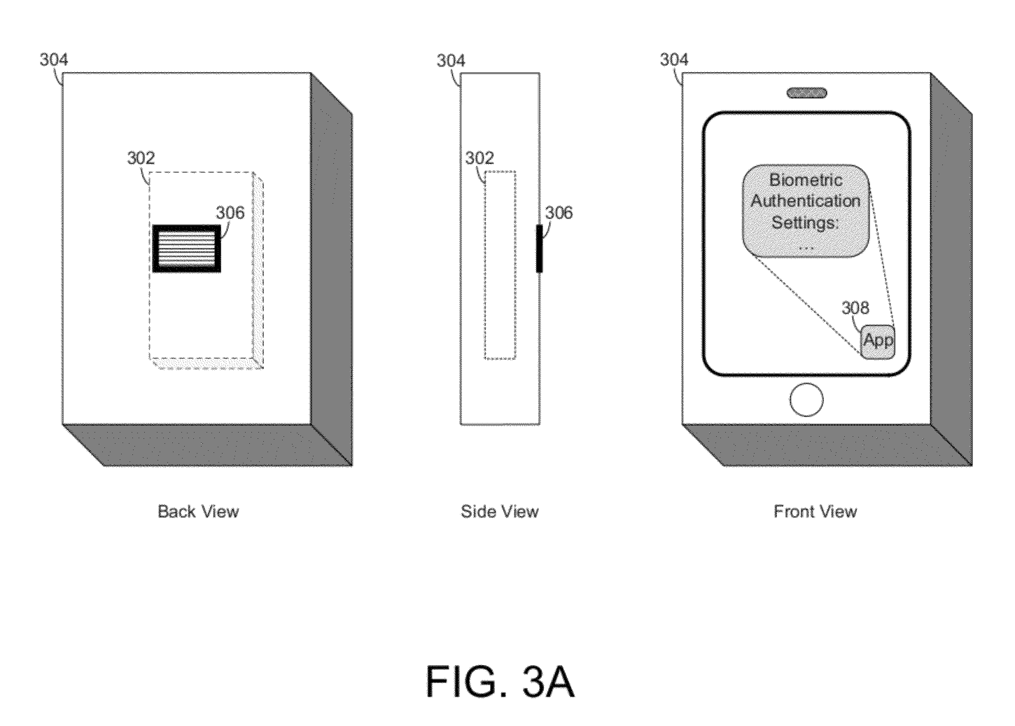

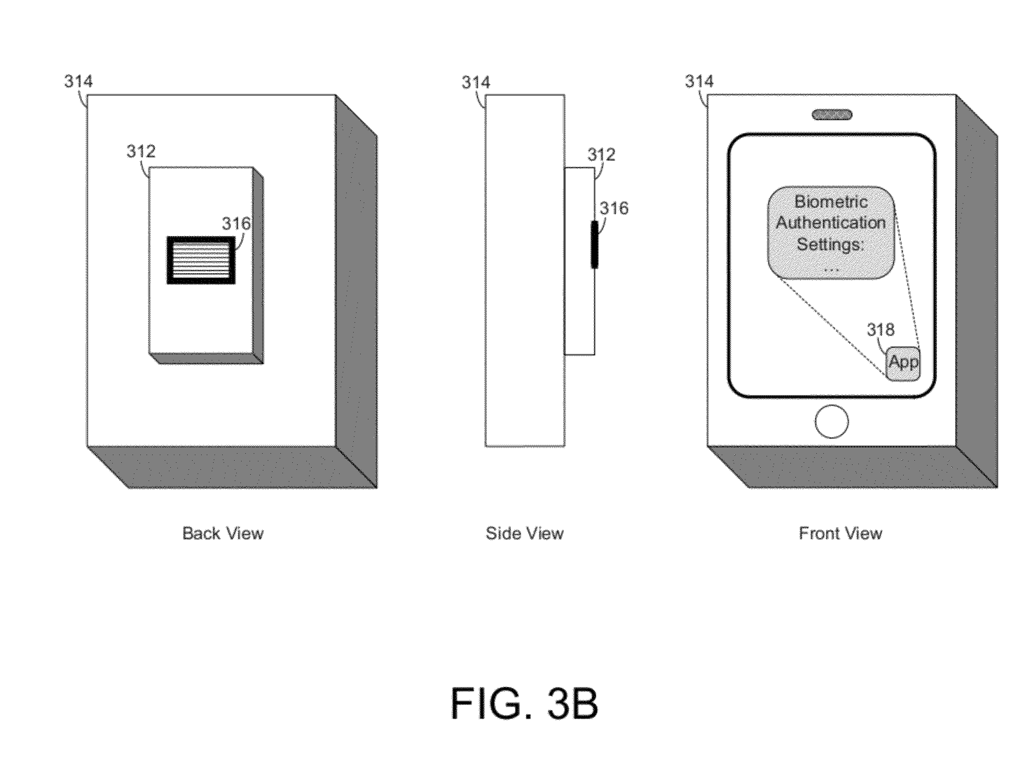

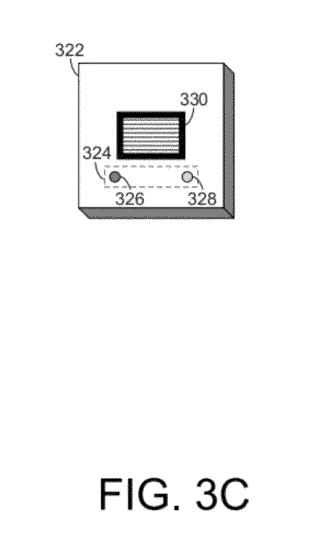

FIG. 3A shows an exemplary device embodiment. In FIG. 3A, a device 302 can be integrated within a portable electronic device 304 (e.g., cellular phone, smart phone, portable gaming device, etc.). When integrated within a portable electronic device 304, the device 302 can communicate with the portable electronic device 304 via an internal connection and can use the portable electronic device's components and resources as its own. For example, the integrated device 302 can use or share the portable electronic device's processor, wireless transceiver (for communicating short range and/or over a computer network), memory, battery, etc. Also, a user can operate the device 302 via the portable electronic device 304 (e.g., the user can interact with an application 308 running on the portable electronic device 304 to use the portable electronic device 304 as a user interface to operate the integrated device 302). The biometric acquisition module 306 of the device 302 can be located externally on the exterior of the portable electronic device 304.

FIG. 3B shows an exemplary device embodiment. In FIG. 3B, a device 312 can be externally attached to a portable electronic device 314. For example, the device 312 can reside on an external case for the portable electronic device 314. When externally attached to a portable electronic device 314, the device 312 can communicate with the portable electronic device 314 via an external connection, such as wireless Bluetooth, a wired connection via USB, phone jack, or other electronic connections, etc. The portable electronic device 314 can provide a user with user interface functionality for operating the device 312 (e.g., the portable electronic device 314 can have software 318 allowing a user to use the portable electronic device 314 as a user interface for the device 312). The biometric acquisition module 316 of the device 312 can reside on the exterior of the device 312. The device 312 can also share/use the portable electronic device's components and resources as its own.

FIG. 3C shows an exemplary embodiment of a biometric authentication device 322. FIG. 3C illustrates a device 322 having a biometric data acquisition module 330, a button(s) for input 326, and an LED light(s) for output 328. The button(s) for input 326 and LED light(s) for output 328 can provide a user interface 324 for a user to operate the device 322 as a stand-alone device. For example, a user can set the device 322 using the input 326 to define certain actions (e.g., use a default payment method, use a default key to open a particular lock). The output 328 can, for example, provide a confirmation signal(s) to the user.

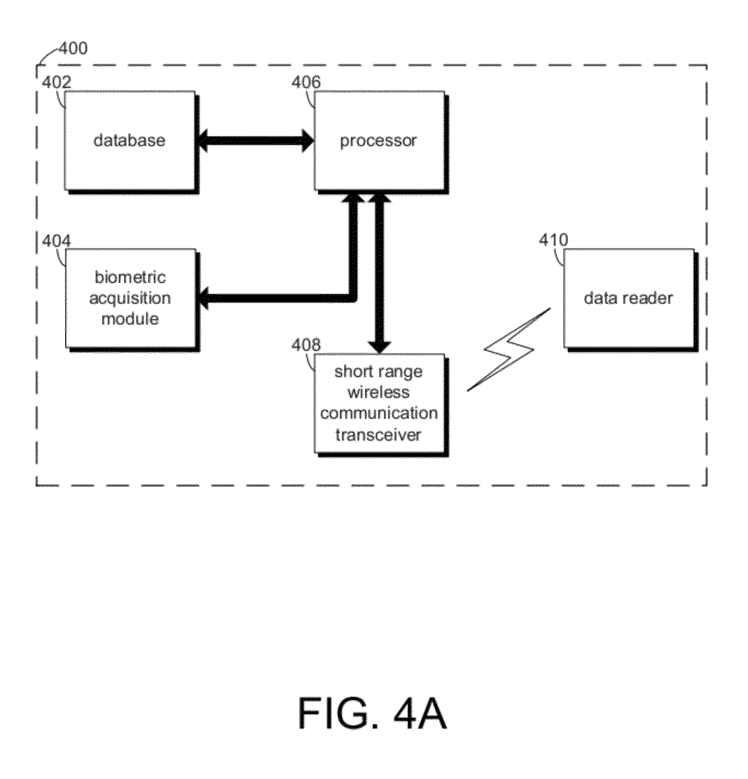

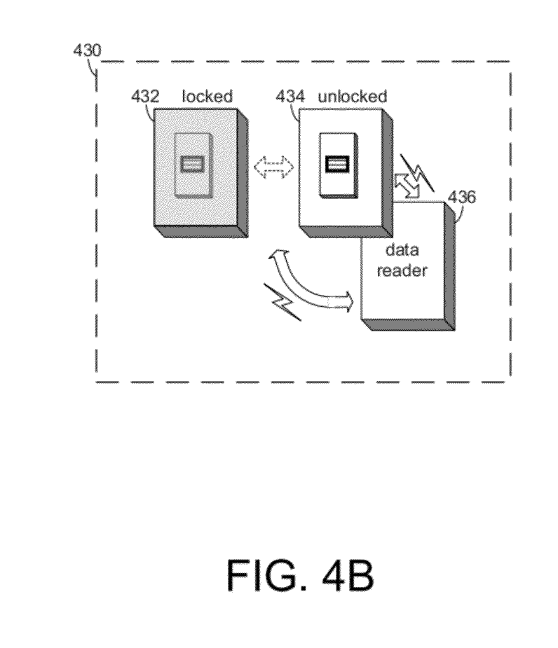

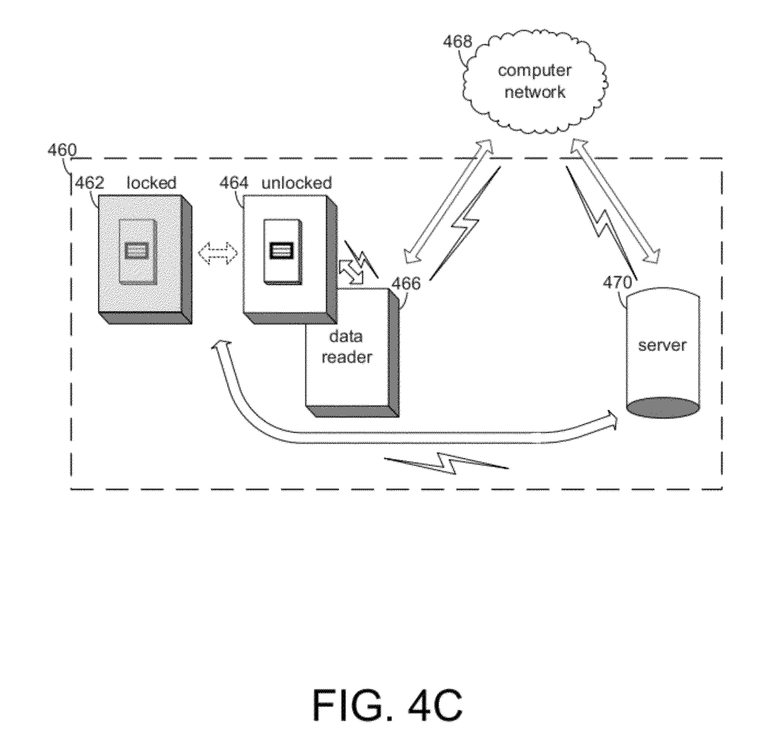

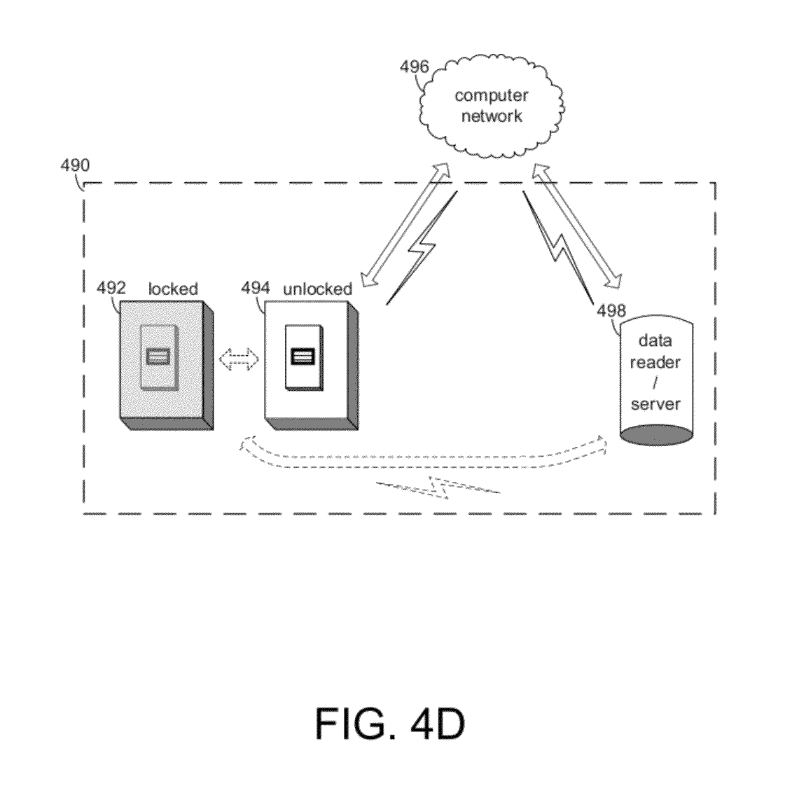

FIG. 4A illustrates an exemplary system embodiment. FIG. 4A shows a system 400 comprising an electronic database 402, a biometric acquisition module 404, a processor 406, a short range wireless communication transceiver 408 and a data reader 410. The electronic database 402 can be configured to store private information. Upon successful authentication of a user, the processor 406 can authorize transmission of private information from the database 402 to the data reader 410. The transmission of private information can be via a short range wireless communication transceiver 408. Furthermore, the system 400 can also optionally comprise a wireless communication transceiver configured to transmit data wirelessly over a computer network, such as the Internet or cellular phone network.

The data reader 410 is configured to utilize the transmitted private information. The data reader 410 can be a small electronic module and can comprise a short range wireless communication transceiver and optionally a wireless communication transceiver for communicating over a computer network. The data reader 410 can receive the private information transmitted via short range wireless communication and/or via wireless communication over a computer network. The data reader can process (e.g., interpret) the private information and provide a response (e.g., perform a defined task). For example, the data reader can provide a confirmation that the private information was received and/or successfully utilized, and/or the data reader can grant access over a barrier (e.g., unlock a lock, open a door, turn on a switch). The data reader 410 can reside at a payment terminal (e.g., a point of sale (POS) terminal, a credit card reader, an electronic cashier, a checkout counter, a subway gateway, a bus/taxi payment terminal), at a barrier (e.g., an electronic lock, an on/off switch), on a computer network (or be connected to a computer network), and/or at other similar locations (e.g., an ATM machine, a security checkpoint).

In some embodiments, a system 430 can comprise a single device 432/434 having an electronic database, a biometric acquisition module, a processor, a short range wireless communication transceiver, and an optional wireless communication transceiver, as shown in FIG. 4B. When not authorizing access to the private information on the electronic database, the device remains “locked” (i.e., the database within the device remains “locked”) 432. The “locked” device 432 prevents unauthorized access to the private information by not allowing a user to access the database if he has not been biometrically authenticated. If a user has been biometrically authenticated, then the device becomes “unlocked” 434. The “unlocked” device 434 can authorize access to the private information. For example, the “unlocked” device 434 can authorize transmission of the private information on the database to a data reader 436 via the device's short range wireless communication transceiver and/or via its wireless communication transceiver for communicating over a computer network. The data reader 436 can receive the private information, process/utilize it, and provide a response (e.g., provide a confirmation signal back to the device, play a “beep” sound, display a message, grant access over a barrier).

In some embodiments, a user stores private information in the form of an electronic key (or passcode, security code, etc.) in the database of the device 432/434. When not biometrically authenticated, the device is locked 432 and cannot authorize access to the key stored in the database. However, when a user is successfully biometrically authenticated, the device becomes unlocked 434 and can authorize transmission of the key via the device's short range wireless communication transceiver to a data reader 436, which is located at a barrier (e.g., an electronically lock). Upon transmission of the key to the data reader 436, the authenticated user is granted access over the barrier (e.g., the electronic lock is unlocked).

In some embodiments, a system 460 can comprise a server 470 configured to facilitate transmission of private information over a computer network 468 and process the private information, as shown in FIG. 4C. The server 470 can be connected to and/or reside on the computer network 468. For example, a locked device 462 can be unlocked when a user is successfully biometrically authenticated. The unlocked device 464 can then authorize access to the private information in the database of the device; the unlocked device 464 can authorize transmission of the private information via short range wireless communication and/or optionally via wireless communication over a computer network. The data reader 466 receives the transmitted private information and can send data relating to the transaction/interaction (the data can include the private information) to the server 470 over the computer network 468. The server 470 can process and utilize the data (e.g., including the private information) and provide a response (directly or via the data reader 466). For example, the server 470 can transmit a confirmation back to the device and/or grant access over a barrier (or command the data reader 466 to do so).

In some embodiments, a user can make a secure monetary transaction (e.g., purchase), similar to a payment transaction achieved when a credit card is swiped. A user's credit card, online payment, and/or ATM card information, etc. (private information) is stored in the database of the device 462/464. When the user is biometrically authenticated, then the device is unlocked 464 and can authorize transmission of the private (e.g., credit card) information to the data reader 466 via the device's short range wireless communication transceiver. For example, the user can use his fingerprint for biometric authentication to unlock the device 464, select a method of payment from any of the private information stored (e.g., the user can select a credit card he wants to use, or can simply use the default payment method that was previously set in the device 464), and then place the unlocked device 464 near the data reader 466 such that the unlocked device 464 transmits the credit card information to the data reader 466 via short range wireless communication. The data reader 466 receives the transmitted credit card information, utilizes it, and provides a response (which can include transmitting a confirmation, receipt, and/or other information back to the device). Additionally or alternatively, the data reader 466 can transmit data relating to the purchase (which can include data about the user's payment information) over a network 468 to a server 470. The server 470 can utilize the data, process the purchase (e.g., accept the purchase), and send a response (e.g., a confirmation email message, a sales receipt, shopper's loyalty points, a shopping coupon) back to the device. After a set amount of time (e.g., shortly after payment is complete), the device will be automatically locked 462 again.

While specific examples and embodiments are described above, it should be understood that this is for illustration purposes only. One of ordinary skill in the relevant art will recognize that many variations and modifications may be used without departing from the scope and spirit of the present disclosure. For example, in some embodiments, a server can be configured to receive information from multiple data readers to perform more complex tasks. Moreover, in some embodiments, a system 490 can comprise a data reader 498 located at a server 498 connected to (and/or residing in) a computer network 496, as shown in FIG. 4D, such that the data reader communicates over the computer network 496 and can but needs not include short range wireless communication capabilities. A person of ordinary skill in the art will recognize and understand that many other variations and modifications can be used.

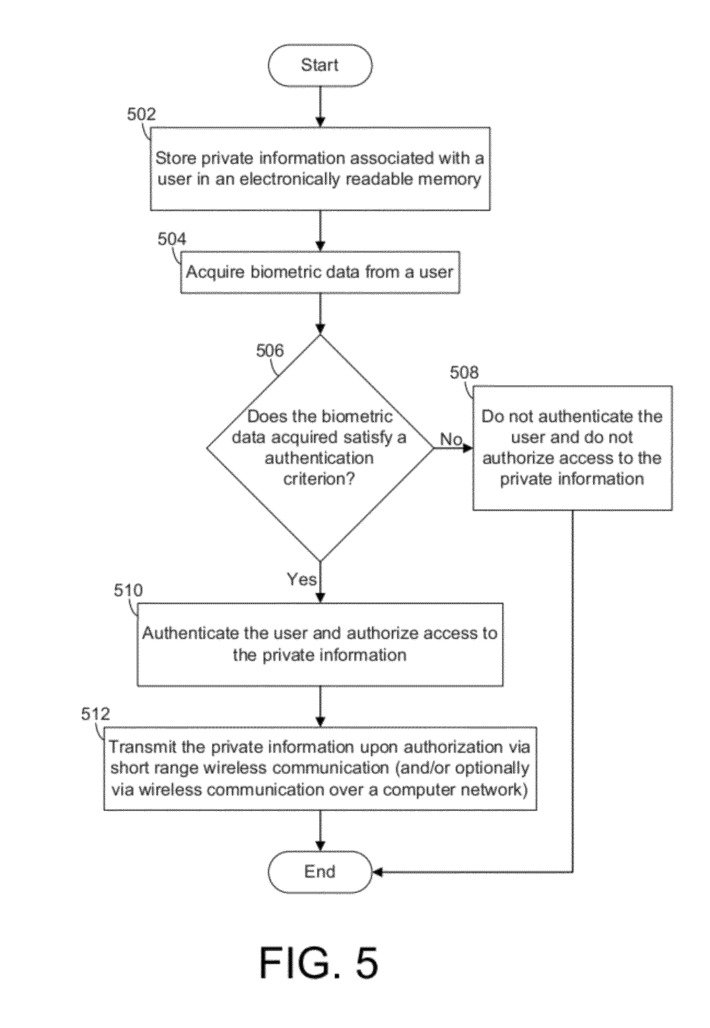

FIG. 5 illustrates an exemplary method embodiment. In some embodiments, a user can securely store his private information (e.g., information relating to credit cards, passcodes, personal information, data, etc.) in an electronically readable memory 502. When the user wants to access the stored private information, biometric data can be acquired from the user 504. The acquiring of biometric data from the user can be performed utilizing fingerprint, hand/palm geometry, voice, face, or eye recognition technologies, or other similar technologies. Based on the biometric data acquired, the method determines whether the data satisfies an authentication criterion 506. If not (i.e., authentication result is negative), then the user is not authenticated and the method does not authorize access to the private information 508 (i.e., the device remains locked). If so (i.e., positive result), then the user is successfully authenticated and the method can authorize access to the private information 510 (i.e., the device is unlocked). Next time when a user wants to access his stored private information, he only needs to provide his biometric data for acquisition 504; the rest of the method embodiment repeats. In this way, the private information can be stored securely in the electronically readable memory (e.g., database), such that unauthenticated users cannot access the information, thereby reducing the probability of unauthorized use. When a user wants to access his stored private information, he only needs to provide his biometric data for acquisition and biometric authentication.

Upon successful authentication, the method can transmit the private information via short range wireless communication 512; and, as mentioned above, the method can additionally or alternatively transmit the private information via wireless communication over a computer network (for example, in situations where short range wireless communication may be inappropriate).

The present disclosure can offer several advantages. These advantages include, but are not limited to, ensuring privacy, providing consolidation, increasing efficiency/speed, and improving security. Regarding privacy, since biometric data is stored locally, a user need not surrender his (private) biometric information. As for consolidation, a user can store all of his private information in the electronic database, thereby eliminating the need to carry various personal items, such as wallets, purses, credit cards, debit cards, keys, insurance cards, bus/train passes, access badges, etc. Moreover, regarding efficiency and speed, a user can perform transactions (e.g., pay with credit card, unlock door) faster and more easily (e.g., compared to sliding/swiping a credit card, and finding, inserting, and turning a physical key). Perhaps most importantly, security is improved and the potential problems of theft and loss are mitigated. For example, if a user's electronic database is lost or stolen, any unauthenticated/unauthorized user will be prevented from accessing the database.

In some embodiments, a user can be, for example, a person, representative, custodian of private information, possessor of private information, or another similar entity.

In some embodiments, a device can utilize a chipset design and/or a bus design. In some embodiments, a system can utilize a chipset design and/or a bus design.

In some embodiments, an electronic database can be, for example, a solid state memory chip, a hard-drive, or some other data structure.

In some embodiments, an initiation process is an initialization, a user fingerprint enrollment process, or a private information set up process.

In some embodiments, a unique characteristic can be a unique feature or a unique trait.

In some embodiments, approving a trait, characteristic, or feature can be defining and/or authenticating it. In some embodiments, approving a criterion can be defining and/or authenticating it.

In some embodiments, the biometric acquisition module can include, but is not limited to, a fingerprint recognizer, a fingerprint sensor, a fingerprint scanner, hand or palm geometry recognizer, voice recognizer, facial recognizer, and/or eye sensor (e.g., retina scanner), etc.

In some embodiments, a user's biometric data can be made into and/or stored as a representation of the user's biometric data. For example, a user's fingerprint can be made into and stored in the form of a digital representation of the fingerprint.

In some embodiments, short range wireless communication may be inappropriate because it may be difficult to achieve, inefficient, unavailable, insufficient, inadequate, etc.

In some embodiments, a computer network can be an intranet, LAN, WAN, WLAN, Bluetooth network, Wi-Fi, WiMax, 2G, EDGE, 3G, 4G, cellular phone network, smartphone network, the Internet, etc. In some embodiments, the system and/or device can directly communicate with the computer network. In some embodiments, the system and/or device can communicate with the computer network through a computer, smartphone, etc.

In some embodiments, a device integrated within a portable electronic device can be placed internally or embedded within the portable electronic device.

In some embodiments, a device can comprise at least one input (e.g., button) and at least one output (e.g., LED light) for user interface purposes. In some embodiments, a device can comprise a display with touch-screen capabilities for user interface purposes.

In some embodiments, a data reader can be an add-on peripheral to an existing POS terminal. In some embodiments, a POS terminal already has a compatible data reader integrated with it. In some embodiments, a data reader can be coupled to and/or work together with a data processing unit. In some embodiments, the data reader can comprise a data processing unit. In some embodiments, a data reader can comprise USB, Bluetooth, Wi-Fi, and/or other connection capabilities to communicate with a POS terminal. In some embodiments, a device can comprise a data reader.

In some embodiments, a user's partial biometric data can be utilized instead of his full biometric data. By only utilizing his partial biometric data, the user's full (private) biometric data will not be surrendered. For example, similar to providing the last four digits of one's social security number, a user's partial fingerprint (or a partial data representation thereof) can be used for verification, confirmation, and/or record keeping purposes, etc. In some embodiments, a user's partial biometric data can be transmitted from a device to a data reader and/or server.

In some embodiments, when a device is in a “locked” state, and/or when the database storing private information is inaccessible, and/or when the transceiver for transmitting private information is in a “non-active” state, any private information temporarily stored or cached in preparation to be transmitted will be erased.

In some embodiments, there can be an additional layer(s) of security. For example, there can be an activation process(es). In some embodiments, a device can only be activated in person. For example, a user providing biometric data to a device (e.g., during first time use) can only be accomplished in person at a physical location (e.g., retail store). In some embodiments, when a user provides biometric data to a device, there can be a (predetermined) waiting period until which the device begins accepting the biometric data. For example, when a user provides additional biometric data (e.g., enrollment of an additional fingerprint), there can be a waiting period of a certain number days until which the device begins accepting that additional biometric data.

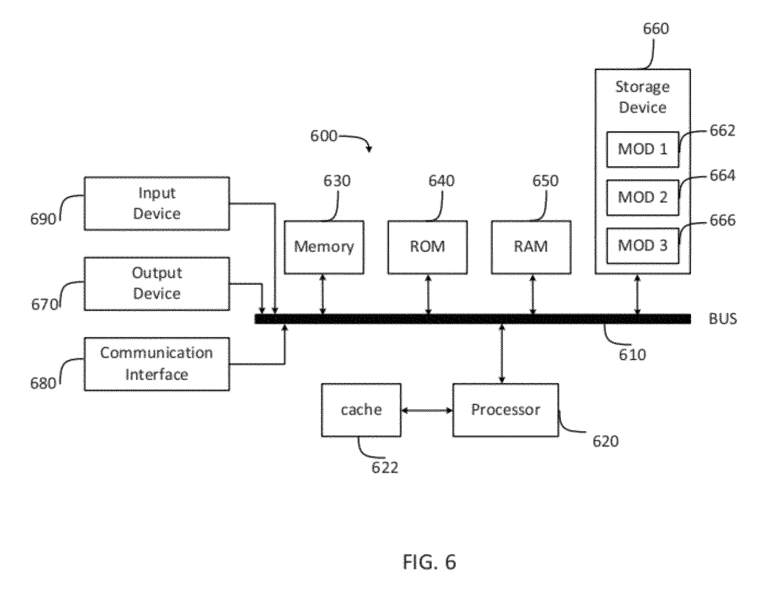

With reference to FIG. 6, an exemplary system 600 includes a general-purpose computing device 600, including a processing unit (CPU or processor) 620 and a system bus 610 that couples various system components including the system memory 630 such as read only memory (ROM) 640 and random access memory (RAM) 650 to the processor 620. The system 600 can include a cache of high speed memory connected directly with, in close proximity to, or integrated as part of the processor 620. The system 600 copies data from the memory 630 and/or the storage device 660 to the cache for quick access by the processor 620. In this way, the cache provides a performance boost that avoids processor 620 delays while waiting for data. These and other modules can control or be configured to control the processor 620 to perform various actions. Other system memory 630 may be available for use as well. The memory 630 can include multiple different types of memory with different performance characteristics. It can be appreciated that the disclosure may operate on a computing device 600 with more than one processor 620 or on a group or cluster of computing devices networked together to provide greater processing capability. The processor 620 can include any general purpose processor and a hardware module or software module, such as module 1 662, module 2 664, and module 3 666 stored in storage device 660, configured to control the processor 620 as well as a special-purpose processor where software instructions are incorporated into the actual processor design. The processor 620 may essentially be a completely self-contained computing system, containing multiple cores or processors, a bus, memory controller, cache, etc. A multi-core processor may be symmetric or asymmetric.

The system bus 610 may be any of several types of bus structures including a memory bus or memory controller, a peripheral bus, and a local bus using any of a variety of bus architectures. A basic input/output (BIOS) stored in ROM 640 or the like, may provide the basic routine that helps to transfer information between elements within the computing device 600, such as during start-up. The computing device 600 further includes storage devices 660 such as a flash memory module, a hard disk drive, a magnetic disk drive, an optical disk drive, tape drive or the like. The storage device 660 can include software modules 662, 664, 666 for controlling the processor 620. Other hardware or software modules are contemplated. The storage device 660 is connected to the system bus 610 by a drive interface. The drives and the associated computer readable storage media provide nonvolatile storage of computer readable instructions, data structures, program modules and other data for the computing device 600. In one aspect, a hardware module that performs a particular function includes the software component stored in a non-transitory computer-readable medium in connection with the necessary hardware components, such as the processor 620, bus 610, display 670, and so forth, to carry out the function. The basic components are known to those of skill in the art and appropriate variations are contemplated depending on the type of device, such as whether the device 600 is a small, handheld computing device, a desktop computer, or a computer server.

Although the exemplary embodiment described herein employs the hard disk 660, it should be appreciated by those skilled in the art that other types of computer readable media which can store data that are accessible by a computer, such as magnetic cassettes, flash memory cards, digital versatile disks, cartridges, random access memories (RAMs) 650, read only memory (ROM) 640, a cable or wireless signal containing a bit stream and the like, may also be used in the exemplary operating environment. Non-transitory computer-readable storage media expressly exclude media such as energy, carrier signals, electromagnetic waves, and signals per se.

To enable user interaction with the computing device 600, an input device 690 represents any number of input mechanisms, such as a microphone for speech, a touch-sensitive screen for gesture or graphical input, keyboard, mouse, motion input, speech and so forth. An output device 670 can also be one or more of a number of output mechanisms known to those of skill in the art. In some instances, multimodal systems enable a user to provide multiple types of input to communicate with the computing device 600. The communications interface 680 generally governs and manages the user input and system output. There is no restriction on operating on any particular hardware arrangement and therefore the basic features here may easily be substituted for improved hardware or firmware arrangements as they are developed.

For clarity of explanation, the illustrative system embodiment is presented as including individual functional blocks including functional blocks labeled as a “processor” or processor 620. The functions these blocks represent may be provided through the use of either shared or dedicated hardware, including, but not limited to, hardware capable of executing software and hardware, such as a processor 620, that is purpose-built to operate as an equivalent to software executing on a general purpose processor. For example the functions of one or more processors presented in FIG. 6 may be provided by a single shared processor or multiple processors. (Use of the term “processor” should not be construed to refer exclusively to hardware capable of executing software.) Illustrative embodiments may include microprocessor and/or digital signal processor (DSP) hardware, read-only memory (ROM) 640 for storing software performing the operations discussed below, and random access memory (RAM) 650 for storing results. Very large scale integration (VLSI) hardware embodiments, as well as custom VLSI circuitry in combination with a general purpose DSP circuit, may also be provided.

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits. The system 600 shown in FIG. 6 can practice all or part of the recited methods, can be a part of the recited systems, and/or can operate according to instructions in the recited non-transitory computer-readable storage media. Such logical operations can be implemented as modules configured to control the processor 620 to perform particular functions according to the programming of the module. For example, FIG. 6 illustrates three modules Mod1 662, Mod2 664 and Mod3 666 which are modules configured to control the processor 620. These modules may be stored on the storage device 660 and loaded into RAM 650 or memory 630 at runtime or may be stored as would be known in the art in other computer-readable memory locations.

The various embodiments and applications described above are provided by way of illustration only and should not be construed to limit the invention. Those skilled in the art will readily recognize various modifications and changes that may be made to the present description without following the example embodiments and applications illustrated and described herein, and without departing from the true spirit and scope of the present disclosure.

We claim:

1. A device comprising:
an electronic database configured to securely store private information;
a biometric acquisition module configured to acquire biometric data from a user;
a processor configured to authenticate the user when the biometric data acquired by the biometric acquisition module satisfies an authentication criterion, and based on the authentication of the user, authorize access to the private information stored in the electronic database; and
a short range wireless communication transceiver configured to transmit the private information as authorized by the processor.

2. The device of claim 1, wherein the biometric acquisition module is a fingerprint recognizer and the biometric data is fingerprint data.

3. The device of claim 1, further comprising:
a biometric authentication algorithm configured to determine whether the acquired biometric data satisfies an authentication criterion.

4. The device of claim 1, wherein the short range wireless communication transceiver utilizes near field communication (NFC) or radio-frequency identification (RFID) technology.

5. The device of claim 1, further comprising:
a wireless communication transceiver configured to transmit the private information as authorized by the processor over a computer network.

6. The device of claim 1, further comprising:
a user interface configured to accept an input from a user and provide an output response, wherein the user interface allows the device to operate as a stand-alone device.

7. The device of claim 1, wherein the device is integrated with a smart phone, the smart phone communicating with the device via an internal connection to provide at least a user interface for operating the device.

8. The device of claim 1, wherein the device is externally attached to a smart phone, the smart phone communicating with the device via an external connection to provide a user interface for operating the device.

9. The device of claim 8, wherein the external connection is a Bluetooth connection.

10. A system comprising:
an electronic database configured to securely store private information;
a biometric acquisition module configured to acquire biometric data from a user;
a processor configured to authenticate the user when the biometric data acquired by the biometric acquisition module satisfies an authentication criterion, and based on the authentication of the user, authorize access to the private information stored in the electronic database;
a short range wireless communication transceiver configured to transmit the private information as authorized by the processor; and
a data reader configured to utilize the private information.

11. The system of claim 10, wherein the biometric acquisition module is a fingerprint recognizer and the biometric data is fingerprint data.

12. The system of claim 10, further comprising:
a biometric authentication algorithm configured to determine whether the acquired biometric data satisfies an authentication criterion.

13. The system of claim 10, wherein the short range wireless communication transceiver utilizes near field communication (NFC) or radio-frequency identification (RFID) technology.

14. The system of claim 10, wherein at least one of the electronic database, the biometric acquisition module, the processor, and the short range wireless communication transceiver is integrated with a smart phone, and the data reader resides separately from the smart phone.

15. The system of claim 10, wherein at least one of the electronic database, the biometric acquisition module, the processor, and the short range wireless communication transceiver is externally attached to a smart phone, and the data reader resides separately from the smart phone.

16. The system of claim 10, further comprising:
a user interface configured to accept an input from a user and provide an output response, wherein the user interface allows the electronic database, the biometric acquisition module, the processor, and the short range wireless communication transceiver to operate together in a stand-alone device, and the data reader resides separately from the stand-alone device.

17. The system of claim 10, wherein the private information is payment information and the data reader resides at a payment terminal.

18. The system of claim 10, wherein the private information is for gaining access over a barrier and the data reader resides at the barrier.

19. The system of claim 10, further comprising:
a wireless communication transceiver configured to transmit the private information as authorized by the processor over a computer network to the data reader.

20. The system of claim 19, further comprising:
a server on the computer network configured to facilitate communication of the private information over the computer network, utilize the private information, and provide a response.

21. The system of claim 19, wherein the data reader resides on a server on the computer network.

22. A computer-implemented method comprising:
storing private information associated with a user in an electronically readable memory;
acquiring biometric data from a user;
authenticating the user when the biometric data acquired satisfies an authentication criterion;
authorizing access to the private information based on a successful authentication of the user; and
transmitting the private information upon authorization via short range wireless communication.

23. The computer-implemented method of claim 22, wherein acquiring biometric data from a user utilizes fingerprint recognition technology.

24. The computer-implemented method of claim 22, wherein authenticating the user utilizes a biometric authentication algorithm.

25. The computer-implemented method of claim 22, wherein transmitting the private information upon authorization via short range wireless communication utilizes near field communication (NFC) or radio-frequency identification (RFID) technology.

26. The computer-implemented method of claim 22, further comprising:
transmitting the private information upon authorization via wireless communication over a computer network.
